(19) United States
(12) Patent Application Publication
(10) Pub. No.: US 2009/0088194 A1
(43) Pub. Date: Apr. 2, 2009

(54) Single Multi-Mode Clock Source for Wireless Devices

(75) Inventors: John Stewart Petty, JR., Chapel Hill, NC (US); Nikolaus Klemmer, Cary, NC (US); Satish Uppathil, Durham, NC (US)

Correspondence Address: COATS & BENNETT, PLLC, 1400 Crescent Green, Suite 300, Cary, NC, 27518, US

(73) Assignee: Telefonaktiebolaget LM Ericsson (publ), Stockholm (SE)

(21) Appl. No.: 11/862,400

(22) Filed: Sep. 27, 2007

(51) Int. Cl. H04B 7/00

(52) U.S. Cl. 455/502

(57) ABSTRACT

The wireless device described herein uses a single crystal oscillator to generate the high and low frequency clock signals required by the wireless device during both active and inactive radio communications. An exemplary multi-mode clock unit comprises a single crystal oscillator operable in a normal power mode and a reduced power mode, and a control unit that selectively switches the crystal oscillator between the first and second power modes based on a current clock signal quality requirement. The control unit may selectively switch between the first and second power modes by selectively varying a capacitive load of the crystal oscillator and/or by varying a drive signal of the crystal oscillator. For example, the control unit may select the normal power mode when a cellular transceiver is active, and a reduced power mode when the cellular transceiver is inactive to reduce power consumption during the inactive state.

### BACKGROUND

The present invention relates generally to wireless devices, and more particularly to generating clock signals for wireless devices.

Wireless devices rely on clock systems to provide accurate timing for a wide range of operations, including radio communications, digital processing, and real time clock operations. High quality clock signals (low noise, high accuracy, etc.) are typically required for radio communications, while lower quality clock signals are typically sufficient for digital processing and real time clock operations. Generating high quality clock signals consumes a large amount of power relative to the lower quality clock signals. However, because radio communication operations are inactive most of the time, the wireless device may conserve power by only activating the high quality clock signal when the radio communication operations are active. One conventional solution achieves this using a multiple clock system. Exemplary multiple clock systems include a high power clock unit that produces a high frequency, high quality clock signal that is active only during radio communication operations, and a lower power clock unit that produces a continuous lower frequency, lower quality clock signal for other less strict device operations, such as digital processing, real time clock, etc. Using a multiple clock system with separate clock units enables the wireless device to deactivate the high power clock unit whenever the radio communication operations are inactive. This provides considerable power savings to the wireless device.

While separate clock units provide power savings, they also increase the cost and size of the device. Further, a multi-clock solution often requires additional calibration and temperature compensation electronics, which further increase the cost, size, and power consumption of the device. Thus, there is a need for alternative clock generation solutions.

### SUMMARY

The present invention uses a single crystal oscillator to generate the clock signals required by a wireless device. An exemplary clock unit comprises a crystal oscillator operable in a first power mode (e.g., a normal power mode) and a second power mode (e.g., a reduced power mode), and a control unit that selectively switches the crystal oscillator between the first and second power modes based on a current clock signal quality requirement. The control unit may selectively switch between the first and second power modes by varying a current consumption of the crystal oscillator. The current consumption of the crystal oscillator may be varied by varying the number of active drivers in a buffer circuit, varying a capacitive load, and/or varying a drive signal of the crystal oscillator. For example, when the wireless device requires a high quality clock signal, e.g., when a radio unit in the wireless device is active, the control unit may select the first power mode to provide a high quality clock signal at the expense of higher power consumption. However, when the wireless device does not require a high quality clock signal, e.g., when the radio unit is inactive, the control unit may select the second power mode to provide a reduced quality clock signal with reduced power consumption.

### BRIEF DESCRIPTION OF THE DRAWINGS

FIG. 1 shows a block diagram of one exemplary wireless device according to the present invention.

FIG. 2 shows a block diagram of one exemplary multi-mode clock unit according to the present invention.

FIG. 3 shows an exemplary process for generating a clock signal according to the present invention.

FIG. 4 shows crystal oscillator output behavior during standby mode.

### DETAILED DESCRIPTION

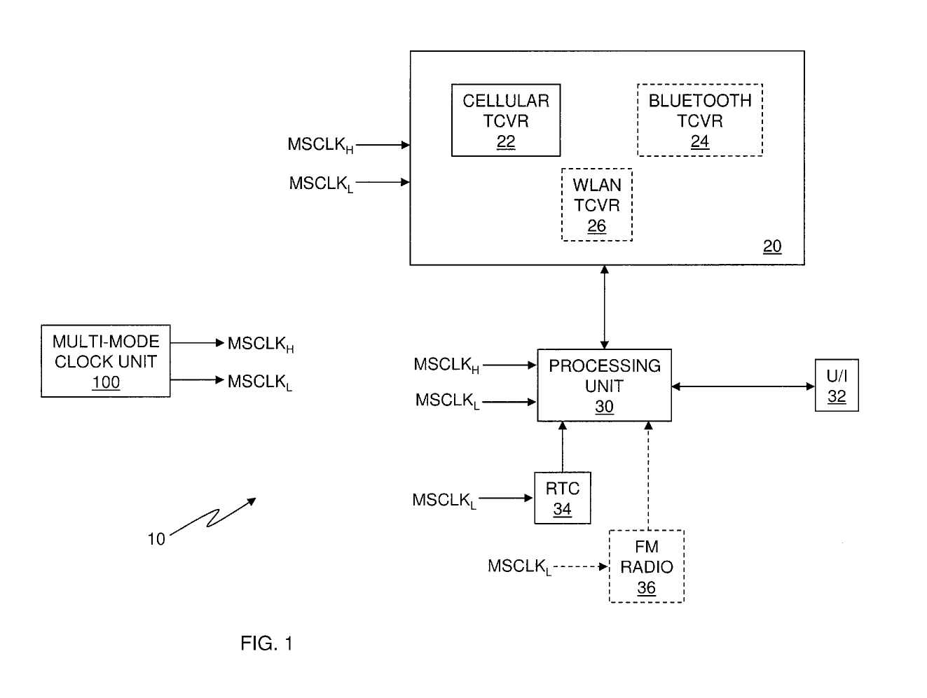

FIG. 1 shows a wireless device 10 according to one exemplary embodiment. Wireless device 10 may comprise any wireless device, including but not limited to, a cellular telephone, a laptop computer, a personal data assistant, and a handheld computer. The wireless device 10 comprises a radio unit 20, a processing unit 30, a user interface 32, a Real Time Clock (RTC) 34, one or more optional peripheral units, such as a Frequency Modulated (FM) radio unit 36, and a clock unit 100. Radio unit 20 comprises one or more wireless transceivers that transmit and receive wireless signals according to any known wireless protocol. An exemplary radio unit 20 may include a cellular transceiver 22, Bluetooth® transceiver 24, and a Wireless LAN (WLAN) transceiver 26 that transmit and receive wireless signals according to their respective wireless protocols. The processing unit 30 processes the communication signals and serves as the overall controller for the wireless device 10. The user interface 32 interfaces the user with the wireless device 10 and may include a display, control buttons, speaker, microphone, etc. RTC 34 uses a continuous low frequency clock signal to track time for the wireless device 10. The FM radio 36 receives and provides FM radio signals to the processing unit for output to the user interface 32 according to any known means. The clock unit 100 provides the clock signals necessary for implementing the functions of the radio unit 20, processing unit 30, RTC 34, and FM radio 36. While not explicitly shown in FIG. 1, it will be appreciated that one or more frequency multipliers and/or dividers may be present in the clock unit 100, radio unit 20, processing unit 30, RTC 34, and peripheral units 36 if further frequency manipulation of the clock signal provided by clock unit 100 is required.

In a conventional wireless device, the clock unit comprises a multi-clock system that includes two separate clock units that provide the necessary clock signals. Conventional multi-clock systems include a low power, low frequency clock unit and a high power, high frequency clock unit. Each clock unit includes a separate crystal oscillator tuned to provide the desired clock signal at the desired frequency. The low frequency clock unit operates all the time to provide a continuous low frequency clock signal with low power consumption (e.g., 5 μA). One exemplary low frequency clock signal comprises a 32768 Hz clock signal. The low frequency clock signal may be used by the processing unit 30, RTC 34, FM radio 36, etc. The high frequency clock unit provides a high quality, high frequency clock signal. Exemplary high frequency clock signals comprise 13 MHz and 26 MHz clock signals. The high frequency clock signal may be used by any element in the radio unit 20 requiring a high quality clock signal, e.g., the cellular transceiver 22. Due to the high frequency and high quality of the generated clock signal, the high frequency clock unit typically consumes significantly more power than the low frequency clock unit. For example, the high speed clock unit may consume 3-4 mA of current.

To conserve power, the conventional multi-clock system only activates the high frequency clock unit on an as needed basis, e.g., when the cellular transceiver 22 is active. When the high frequency clock signal is not needed by any function in the system, e.g., in stand-by mode, the conventional clock system powers down the high frequency clock unit to reduce power consumption. While the high frequency clock unit is powered down, the low frequency clock unit continues to provide the clock signal(s) necessary for the wireless device to monitor the passage of time and to determine when to wake up the radio unit 20.

A conventional multi-clock system has several disadvantages. First, each clock unit adds a specific financial and printed circuit board (PCB) area cost to the wireless device. For example, each crystal oscillator costs between $0.30 and $0.35 and occupies approximately 10 mm² of PCB area. Thus, while multi-clock systems provide sufficient power savings for most wireless device implementations, they also directly conflict with the ongoing trend of reducing the size and cost of wireless devices. Another disadvantage lies with the slow startup time associated with the low frequency clock unit. When a conventional wireless device relies on the low frequency clock unit to provide a clock signal for the processing unit 30, a phase-locked-loop (PLL) is typically required to multiply the low frequency to a higher frequency useful to the processing unit 30. The slow startup times associated with PLLs applied to such low frequency signals may cause additional power consumption for an extended period of time. Further, the slow startup time may affect the manufacturing process, where low frequency clock units require hundreds of milliseconds after power is first applied to start up and stabilize, as compared to high frequency oscillators that may start up and stabilize in 4-10 ms.

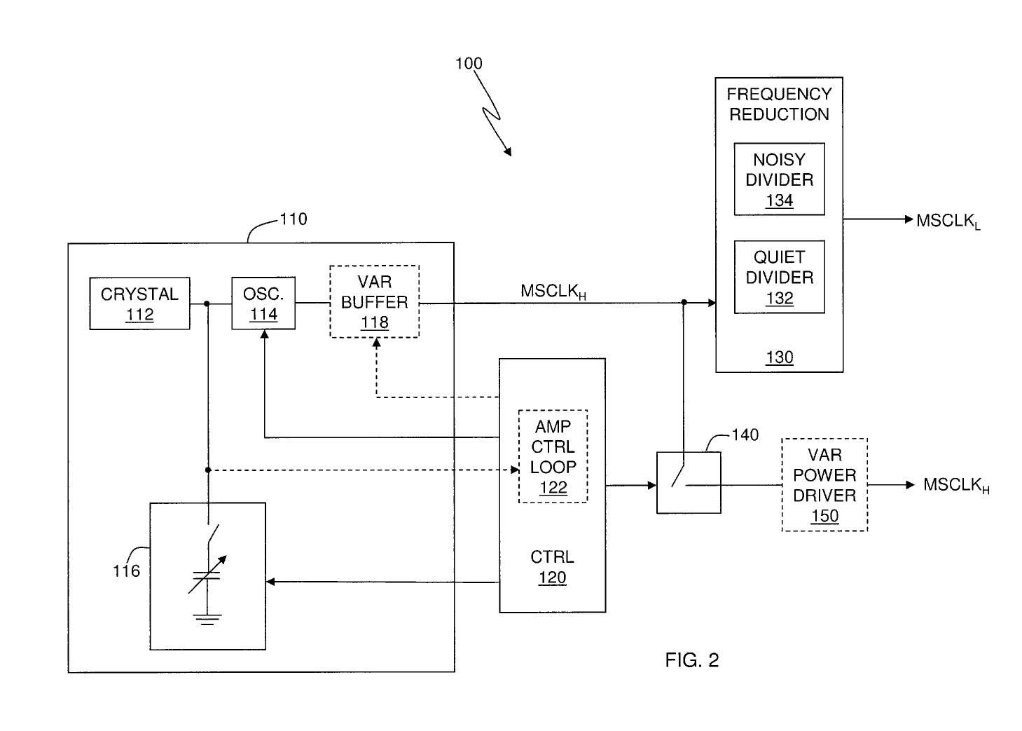

The present invention replaces the multi-clock system of the conventional wireless device with a single multi-mode clock unit 100 comprising a single high frequency crystal oscillator 110 (FIG. 2). Clock unit 100 selectively switches between multiple different power modes while continuously running the high frequency crystal oscillator 110 to provide a high frequency clock signal (MSCLK_{H}) and an optional low frequency clock signal (MSCLK_{L}) while minimizing power consumption. It will be appreciated that the frequency of the clock signal(s) output by the multi-mode clock unit 100 does not significantly change from mode to mode. Generally, the higher the power consumption, the higher the quality of the output clock signals. Thus, a high power mode produces high quality clock signals, while a reduced power mode produces lower quality clock signals. The following describes the invention in terms of a two-mode or three-mode clock unit 100 that selectively switches between a normal power mode and one or more reduced power modes. However, it will be appreciated that the multi-mode clock unit 100 may have any number of power modes.

FIG. 2 shows a block diagram for a multi-mode clock unit 100 according to one exemplary embodiment. Multi-mode clock unit 100 comprises a crystal oscillator 110, a controller 120, and a frequency reduction unit 130. The crystal oscillator 110 outputs a high frequency clock signal (MSCLK_{H}) at the desired frequency (e.g., 13 MHz or 26 MHz) responsive to control signals provided by controller 120. The frequency reduction unit 130 reduces the frequency of MSCLK_{H} to generate a second, lower frequency clock signal MSCLK_{L} at a desired frequency, e.g., 32768 Hz. While not required, the clock unit 100 may further include an optional switch 140 that selectively disables MSCLK_{H} when the wireless device 10 does not require a high frequency clock signal. Further, clock unit 100 may include an optional power driver, e.g., a variable power driver 150, to allow distribution of a high quality or low quality high frequency clock signal while further managing the current consumption of the crystal oscillator 110.

Crystal oscillator 110 comprises a crystal 112, an oscillator 114, and a variable capacitive load 116. The crystal 112 is tuned to vibrate at a predetermined frequency. In the present invention, the crystal 112 is typically tuned to a desired high frequency, e.g., 13 MHz, 26 MHz, etc. Oscillator 114 converts the vibrations produced by crystal 112 to an electrical clock signal at the high frequency (MSCLK_{H}). The capacitive load 116 tunes the frequency of the vibrating crystal 112 responsive to control signals from the control unit 120 to help reduce errors in the frequency of the output clock signal. As shown in FIG. 2, the capacitive load 116 may comprise a variable capacitor. Alternatively, the capacitive load 116 may comprise a plurality of capacitors that are selectively switched in and out to provide the desired load capacitance. While not explicitly shown, it will be appreciated that crystal oscillator 110 may comprise a differential crystal oscillator.

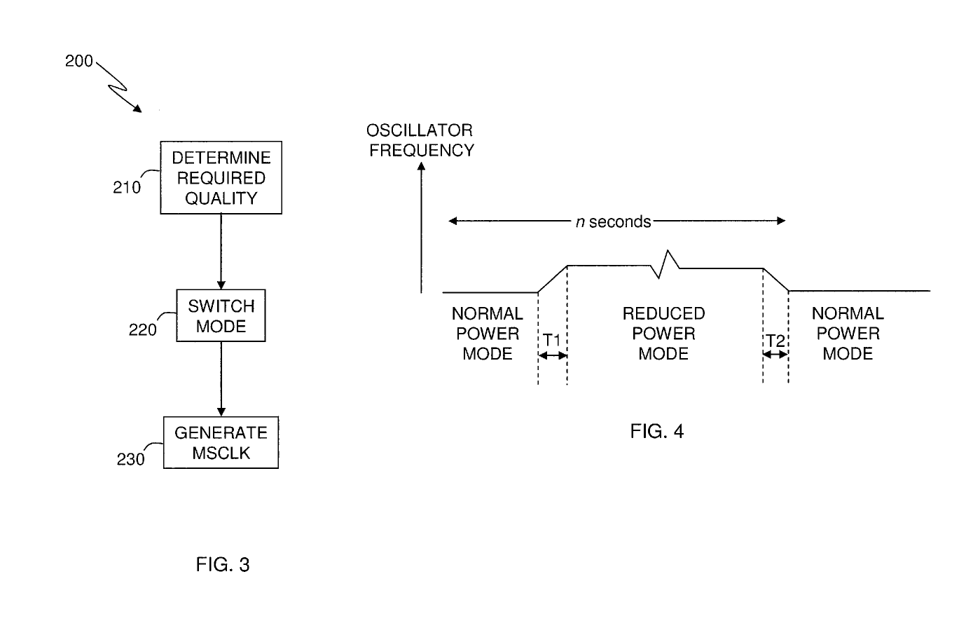

To minimize power consumption, the control unit 120 selectively switches the crystal oscillator 110 between power modes based on a current clock signal quality requirement. FIG. 3 shows one exemplary method 200 implemented by control unit 120 for generating one or more clock signals using the multi-mode clock unit 100. The control unit 120 determines the required clock signal quality (block 210) according to any known means. For example, the control unit 120 may determine the required quality by monitoring the status of cellular transceiver 22 (e.g., monitoring when transceiver 22 is active). Subsequently, control unit 120 switches to the power mode corresponding to the determined clock signal quality requirement (block 220), and the clock unit 100 generates the corresponding clock signal(s) (block 230). For example, when transmitting a wireless signal via cellular transceiver 22, the control unit 120 switches to the normal power mode to provide high quality clock signals. Conversely, when the cellular transceiver 22 is inactive, the control unit 120 may switch to a reduced power mode, to provide lower quality clock signals while consuming less power. Table 1 lists various clock signal quality requirements for different wireless device functions. It will be appreciated that Table 1 is not exhaustive.

TABLE 1

| Quality Requirement | Power Mode | Exemplary function(s) |
|---|---|---|
| High | Normal | wireless communications |
| | | (cellular, Bluetooth ®, WLAN, |
| | | etc.) |
| Medium/Low | Reduced | RTC, FM radio, baseband |
| | | processing, some wireless |
| | | communications (Bluetooth ®, |
| | | WLAN, etc.) |

Controller 120 controls the power mode of the crystal oscillator 110 by controlling the current consumption of the crystal oscillator 110. The controller 120 may control the current consumption by controlling the capacitive load 116, the drive signal of the crystal oscillator 110, or both. It will be appreciated that the controller 120 may switch the crystal oscillator 110 between any two power modes, any three power modes, or any predetermined number of power modes. Controller 120 may control the oscillator drive signal by controlling the oscillator drive current or the oscillator supply voltage. The controller 120 may control the capacitive load 116 by selectively connecting or disconnecting the capacitive load 116. For example, the controller 120 may switch between a normal power mode and a medium reduced power mode by reducing the oscillator drive signal while maintaining the load capacitance. It will be appreciated that further power savings for the medium reduced power mode may be achieved by eliminating the active control of load 116. The controller 120 may also switch to a low reduced power mode by disconnecting the load 116 and reducing the oscillator drive signal.

The controller 120 may alternatively or additionally control the current consumption of the crystal oscillator 110 by controlling an optional buffer circuit 118. Buffer circuit 118 may comprise multiple parallel drivers. In one embodiment, the buffer circuit 118 may comprise a linear amplifier and limiter (not shown). For the normal power mode, the buffer circuit 118 amplifies and isolates the signal across the crystal 112 and/or oscillator 114 to produce a high quality square wave that allows the crystal oscillator 110 to produce the desired high quality clock signal. For the reduced power mode(s), the controller 120 may disconnect or disable one or more drivers in the buffer circuit 118 to reduce the current consumption. The controller 120 may control the buffer circuit 118 according to noise requirements and desired current consumption. While FIG. 2 shows the optional buffer circuit 118 as part of crystal oscillator 110, it will be appreciated that the buffer circuit 118 may be separate from crystal oscillator 110.

In some embodiments, the controller 120 may include an optional amplitude control loop 122 that helps maintain the crystal oscillator 110 at a desired current consumption to maintain oscillation during the medium and/or low reduced power modes. For example, the amplitude control loop 122 may detect the amplitude across the crystal 112, compare the detected amplitude to a predetermined reference amplitude, and control the oscillator current based on the comparison. To reduce the power impact of the amplitude control loop 122, the controller 120 may activate the amplitude control loop 122 for a predetermined period of time to select the current value, and subsequently deactivate the amplitude control loop 122 and use the selected current value to control the crystal oscillator 110.

The frequency of the high frequency clock signal MSCLK_{H} generated in each power mode does not significantly change. However, the quality of the clock signal and the power consumption of the crystal oscillator 110 changes from mode to mode. Table 2 lists exemplary accuracy and power consumption values for a high frequency clock signal generated by the crystal oscillator 110 when operating in each of a normal power mode, a medium reduced power mode, and a low reduced power mode. In Table 2, “ppm” represents parts per million.

TABLE 2

| | | | Power | | | Noise |
|---|---|---|---|---|---|---|
| Power Mode | Drive Current | Cap. Load | Consumption | Accuracy | | Differential |
| Normal | 700 μA | 10 pF | 3-4 mA | ±0.1 | ppm | N/A |
| Medium | 200 μA | 10 pF | 300 μA | ±1 | ppm | 15 dB |
| Reduced | | | | | | |
| Low Reduced | 25 μA | disconnect | 50 μA | 200-1000 | ppm | 20 dB |

The frequency reduction unit 130 may reduce the high frequency clock signal to generate a second lower frequency clock signal MSCLK_{L} for those elements in the wireless device 10 that need a lower frequency clock signal. To that end, frequency reduction unit 130 comprises at least one of a quiet divider 132 and a noisy divider 134. The quiet divider 132 divides the input clock signal by a predetermined value without adding noise or jitter to the reduced frequency output clock signal. In one embodiment, the quiet divider 132 generates the low frequency clock signal without adding noise or jitter by dividing the input clock signal by an integer divisor, e.g., 793. In another embodiment, the quiet divider 132 generates the low frequency clock signal with almost no noise or jitter added by dividing the input clock signal by a fractional divisor that ends in 0.5, e.g., 793.5. This fractional technique works by counting both rising and falling edges of the input clock frequency. The quiet divider 132 could also implement either technique by deleting an appropriate number of edges to create a jitter free lower frequency output clock signal.

Noisy divider 134 divides the input clock signal by any fractional divisor that does not end in 0.5. While such fractional division typically adds noise and/or jitter to the low frequency output clock signal, the noisy divider 134 has the advantage of being able to divide the input clock signal by high precision fractional divisors, e.g., 793.457. Exemplary noisy dividers 134 comprise a fractional synthesizer/divider as described in US publication 2005/197073 and patent WO-2006 045346 by Klemmer et al., and a delta-sigma fractional divider described by U.S. Pat. No. 6,708,026 by Klemmer et al., both of which are incorporated herein by reference.

While FIG. 2 shows a frequency reduction unit 130 with both a quiet divider 132 and a noisy divider 134, it will be appreciated that the frequency reduction unit 130 may include only one divider or multiple additional dividers. Further, it will be appreciated that the frequency reduction unit 130 will only use one of the dividers 132, 134 at a time based on the desired accuracy of the division and the desired quality of the lower frequency output clock signal MSCLK_{L}. It will also be appreciated that the dividers 132, 134 are not limited to fixed (static) divisors, and therefore, may use a different divisor (dynamic divisor) from one division operation to the next. For example, the quiet divider 132 may divide a 26 MHz clock signal generated during the normal power mode by 26,000,000 to obtain a 1 Hz clock signal. However, during the reduced power mode, the quiet divider 132 may divide an input 26.026 MHz clock signal by 26,026,000 to generate the 1 Hz clock signal. It will further be appreciated that the frequency reduction block 130 is not required to be part of the clock unit 100. For example, clock unit 100 may provide the high frequency clock signal MSCLK_{H} directly to another element in the wireless device 10, e.g., the RTC 34, where the RTC 34 divides down the frequency of the received clock signal as necessary.

Mode transition issues associated with wireless standby operations may arise when a single crystal oscillator 110 is used to generate the low and high frequency clock signals for the wireless device 10. When a wireless device 10 is in standby mode, it consumes minimal power for some period of time—typically one to two seconds, and then “wakes up” to receive a network control channel signal for roughly 50 ms. For GSM operation, the wireless device 10 must wake up within ±2 symbols of the nominal wake up time, and preferably within ±1 symbol of the nominal wake up time. Looser tolerances are possible but would require the wireless device 10 to receive and store more data from the network and it would need more processing power to decode that data.

When the radio unit 20 is receiving data on the control channel, the clock unit 100 is in the normal power mode. When the radio unit 20 is inactive, the clock unit 100 switches to a reduced power mode and stays in that mode for up to roughly 2 seconds. During transitions into and out of the reduced power mode, particularly a low reduced power mode, the output frequency of the oscillator 110 may change. FIG. 4 shows exemplary behavior of the crystal oscillator 110 during a standby mode lasting n seconds.

There are two potential areas of frequency uncertainty during standby operations: frequency uncertainty during the transition periods T1 and T2 and the frequency uncertainty during the time period associated with the reduced power mode. For the transition periods, assume the average frequency F during the total transition time T=T1+T2 is given by:

$$\overline{F} = F + \frac{Δ F}{2} , \qquad ( 1 )$$

where F represents the oscillator frequency in normal (high) power mode and F+ΔF represents the oscillator frequency in reduced power mode, which is expected to be less than 1000 ppm greater than F. If the actual frequency is F during the entire period T, then the timing error E during the entire period T in seconds is given by:

$$E = \frac{Δ F}{F} \cdot \frac{T}{2} . \qquad ( 2 )$$

If the actual frequency is F+ΔF during the entire period T, then the timing error E is given by:

$$E = Δ F \cdot \frac{T}{2 ( F + Δ F )} . \qquad ( 3 )$$

Based on Equations (2) and (3), a reasonable worst case error estimate E in seconds is given by Equation (2). Because GSM has 13 million/48 symbols per second, the error E_{symb} in symbols is given by:

$${E}_{symb} = \frac{13 \text{,} 000 \text{,} 000}{48} \cdot E \qquad ( 4 )$$

When F=26 MHz, and ΔF=0.001 F (e.g., 1000 ppm), then the error in symbols E_{symb} resulting from Equation (4) is 135.4T. For T=4 ms, that is roughly 0.54 symbols which is well within our desired timing window. Further study may allow further error reduction. For example, assuming the oscillator frequency change is an exponential waveform during the transition periods may allow us for a more accurate average frequency estimate than ΔF/2.

During the reduced power mode, the frequency error is caused by the magnitude of the difference between the estimated and actual frequency during the reduced power mode. If Fₑₛₜ represents the estimated frequency during the reduced power mode, and Tₛ represents the desired duration of the sleep period, then the wireless device 10 will count FₑₛₜTₛ clock cycles to measure period Tₛ. If the actual clock frequency is Fₑₛₜ+F_{eTT} where F_{eTT} is the frequency error, then the actual time measured Tₘ is given by:

$${T}_{m} = \frac{{F}_{est} {T}_{s}}{{F}_{est} + {F}_{err}} \qquad ( 5 )$$

The allowed timing error Eₐ in seconds is given by:

Eₐ=Tₛ−Tₘ, (6)

which results in:

$$\frac{{F}_{err}}{{F}_{est}} = \frac{{E}_{a}}{{T}_{s} - {E}_{a}} . \qquad ( 7 )$$

Equation (7) shows that Eₐ/Tₛ represents a close estimate of the necessary accuracy of Eₐ. When Eₐ is one symbol, which corresponds to 3.7 μs for GSM, and when Tₛ is 2 seconds, then 0.00000185 (1.85 ppm) of frequency accuracy is needed.

At room temperature, this accuracy is easily obtained because the wireless device 10 will be calibrated in the factory so its software will know the exact frequency at room temperature for the reduced power mode. However, as the wireless device 10 ages and/or as the temperature changes, the output frequency for the reduced power mode also changes. The wireless device 10 may estimate the actual operating frequency based on the measured temperature, a timing error measured during the last successful sleep cycle, and the capacitive load setting needed for the normal power mode to produce the desired frequency. Because the shape of the temperature versus frequency curve of the crystal oscillator 110 is the same at high power and low power, the wireless device 10 may estimate the actual oscillator frequency in the reduced power mode as the temperature changes. Alternatively, a medium reduced power mode may be used during the sleep periods to reduce the effects of temperature on frequency at the expense of higher power consumption. It will be appreciated that the above-discussed errors are not cumulative because the wireless device 10 performs a timing correction/calibration each time it wakes up to compensate for any Doppler shift caused by a change in the velocity of the wireless device within the network.

Another issue that may arise with a single crystal oscillator 110 involves the accuracy of the RTC 34. RTC 34 has two modes of operations. In a first mode, the wireless device 10 is powered off. In a second mode, the wireless device 10 is powered on and in standby mode. When the wireless device 10 is powered off, the temperature is unknown so the clock frequency output by the multi-mode clock unit 100 when in the reduced power mode could vary by as much as 10 ppm. Thus, for every 24 hours the wireless device 10 is powered off, the wireless device 10 may gain or lose 0.9 seconds. That roughly corresponds to 26 seconds per month, which is ten times better than what can be achieved from typical 32768 Hz clock sources used by conventional wireless devices.

When the wireless device 10 is powered on, most of the time is spent in standby mode, which enables software to update the RTC 34 by counting standby clock cycles. This process results in essentially zero error in the RTC 34 because standby timing errors are not cumulative, as discussed above. However, when the RTC 34 response is not coupled to standby operation, the timing error is cumulative. In that case, the RTC 34 may include a divider that switches between a normal and reduced power mode, e.g., dividing by 26 million during the high power mode and by 26,026,000 during the reduced power mode. In that case, the timing error from the transition periods would be cumulative. Using Equation (2) and assuming F=26 MHz, ΔF=0.001 F (e.g., 1000 ppm), T=4 ms, the resulting timing error E is approximately 0.1 seconds for every 8 hours of standby operation, which corresponds to approximately 3.5 seconds per month assuming 8 hours of standby per day. Thus, including a variable divider in the RTC 34 is preferable when desiring to keep the operation of the RTC 34 independent of the remainder of the wireless device 10 as much as possible. The variable divider could be set up by software with two values and then hardware could change between the two divider ratios automatically as the clock unit 100 switches between power modes.

For the embodiments that disconnect or otherwise remove the capacitive load 116, another potential issue involves the transients that may occur in the clock signal during the mode transition. These transients are caused by the constant charging and discharging of the capacitive load 116, e.g., when the capacitive load 116 is not fully charged during the transition. Such transients distort the clock signal. To minimize the distortion, the controller 120 may time the power mode transitions to occur when the capacitive load 116 is fully charged.

The above assumes that the various wireless elements in radio unit 20 have the same general clock signal quality requirements. However, the present invention may be used in wireless devices 10 having different clocking requirements for different radio elements. For example, Bluetooth® transceiver 24 may require a high frequency clock signal with an accuracy of ±20 ppm and jitter of less than 300 ps, and a low frequency clock signal with an accuracy of ±250 ppm. A high speed USB transceiver (not shown) may require a high frequency clock signal with an accuracy of at ±200 ppm and less than 300 ps of jitter. Wireless communications that satisfy IrDA may require a high frequency clock signal with an accuracy of 10,000 ppm and jitter of 2.5 ns or less. Wireless LAN and GPS elements may have very demanding clock requirements.

It might be possible to use the single clock unit 100 presented above to meet all of these clock signal requirements in a high end wireless device 10. However, such a solution would make it necessary to run the clock unit 100 in the normal (high) power mode much or all of the time. Further, scheduling frequency adjustments for the clock unit 100 could be difficult because a frequency adjustment often produces clock jitter. One solution that meets the multiple clock needs provides a second multi-mode clock unit 100. The second multi-mode clock unit 100 may be used in any number of ways. For example, the second clock unit may be used as:

a low power, low frequency oscillator for a mid-tier wireless device.

a low power, high frequency oscillator in a mid tier wireless device requiring a low jitter clock with accuracy in the range of ±20 ppm.

a high power, high frequency “clean output” oscillator with the possibility of frequency adjustments done on a schedule that could be independent of the operation of the cellular transceiver.

The above-described clock unit 100 allows a wireless device to be built using a single crystal oscillator 110 to save the cost and space of a separate 32768 Hz crystal oscillator and associated electronics. Although lower cost and smaller space are the main benefits of the invention, the present invention also has the advantage that the clock signal(s) produced in the reduced power mode are more accurate over temperature (roughly ±10 ppm) than the traditional low power clock generated by a separate 32 kHz crystal (roughly ±100 ppm). This temperature accuracy may improve the long term accuracy of any RTC 34 in the wireless device 10 and may simplify any temperature compensation software used to keep the traditional low power clock usable as a timing source during standby. An additional advantage of the present invention is that its high frequency operation makes its startup time much shorter than that associated with a typical 32 kHz clock. Such shorter startup times may reduce or eliminate dead time during calibration and test in manufacturing. Further, the shorter startup time may have a positive impact on power consumption because it should allow the clock unit 100 to be used in high power mode for less time. For example, conventional estimates show that standby current decreases by 15 μA for every additional 1 ms that the high power clock can be turned off. During standby operations today, the conventional wireless device turns on the high power clock unit roughly 10 ms before it is needed to allow the clock to start up and stabilize. With the present invention, this “startup” time for the multi-mode clock unit 100 may be reduced to 100 μs.

The present invention may, of course, be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method of generating a clock signal in a wireless device, the method comprising:
selectively switching a single crystal oscillator between first and second power modes based on a current clock signal quality requirement to generate the clock signal.

2. The method of claim 1 wherein switching the crystal oscillator between the first and second power modes comprises selectively varying a current consumption of the crystal oscillator.

3. The method of claim 2 wherein selectively varying the current consumption comprises varying a capacitive load of the crystal oscillator.

4. The method of claim 2 wherein selectively varying the current consumption comprises varying a crystal oscillator drive signal.

5. The method of claim 2 wherein selectively varying the current consumption comprises:
varying a capacitive load of the crystal oscillator; and
varying a crystal oscillator drive signal.

6. The method of claim 1 further comprising switching the single crystal oscillator between the first power mode, the second power mode, and a third power mode based on the current clock signal quality requirement.

7. The method of claim 1 wherein the clock signal quality requirement comprises a first clock signal quality requirement for radio transceiver communications and a second clock signal quality requirement for one of a processing function, a real time clock function, and a frequency modulated radio receiving function.

8. The method of claim 1 further comprising reducing the frequency of the clock signal to generate a lower frequency clock signal.

9. The method of claim 8 wherein reducing the frequency of the clock signal comprises:
selecting one of first divider and a second divider, said second divider adding less noise to the input clock signal than the first divider; and
dividing the frequency of the clock signal using the selected divider.

10. A clock unit configured to generate a clock signal in a wireless device comprising:
a crystal oscillator operable in a first power mode and a second power mode; and
a control unit to selectively switch the crystal oscillator between the first and second power modes based on a current clock signal quality requirement.

11. The clock unit of claim 10 wherein the control unit selectively switches the crystal oscillator between the first and second power modes by selectively varying a current consumption of the crystal oscillator.

12. The clock unit of claim 11 further comprising a capacitive load operatively associated with the crystal oscillator, wherein the control unit selectively varies the current consumption by selectively varying the capacitive load.

13. The clock unit of claim 11 wherein the control unit selectively varies the current consumption by selectively varying a crystal oscillator drive signal.

14. The clock unit of claim 11 further comprising a capacitive load operatively associated with the crystal oscillator, wherein the control unit selectively varies the current consumption by selectively varying the capacitive load and selectively varying a crystal oscillator drive signal.

15. The clock unit of claim 11 further comprising an amplitude control loop configured to maintain the crystal oscillator at a desired current consumption.

16. The clock unit of claim 10 wherein the crystal oscillator is further operable between the first power mode, the second power mode, and a third power mode, and wherein the control unit selectively switches the crystal oscillator between the first power mode, the second power mode, and the third power mode based on the current clock signal quality requirement.

17. The clock unit of claim 10 wherein the clock signal quality requirement comprises a first clock signal quality requirement for radio transceiver communications and a second clock signal quality requirement for one of a processing function, a real time clock function, and a frequency modulated radio receiving function.

18. The clock unit of claim 10 further comprising a frequency reduction unit configured to reduce the frequency of the clock signal to generate a lower frequency clock signal.

19. The clock unit of claim 18 wherein the frequency reduction unit comprises at least one of a first divider and a second divider, said second divider adding less noise to the input clock signal, wherein the frequency reduction unit reduces the frequency of the clock signal by selecting one of the first and second dividers and dividing the frequency of the clock signal using the selected divider.

20. A wireless communication device comprising:
a radio unit to transmit and receive wireless communication signals according to a predetermined wireless protocol;
a processing unit to process the wireless communication signals;
a clock unit comprising:
a crystal oscillator operable in a first power mode and a second power mode; and
a control unit to selectively switch the crystal oscillator to the first power mode when the radio unit is active and to the second power mode when the radio unit is inactive.

21. The wireless communication device of claim 20 wherein the control unit selectively switches the crystal oscillator between the first and second power modes by selectively varying a current consumption of the crystal oscillator.

22. The wireless communication device of claim 20 wherein the crystal oscillator is further operable between the first power mode, the second power mode, and a third power mode, and wherein the control unit selectively switches the crystal oscillator between the first power mode, the second power mode, and the third power mode by selecting the first power mode when the radio unit is active and by selecting the second power mode or the third power mode when the radio unit is inactive.

23. The wireless communication device of claim 22 wherein the control unit selects the second or third power mode based on a current clock signal quality requirement.

24. The wireless communication device of claim 20 further comprising a frequency reduction unit configured to reduce the frequency of the clock signal to generate a lower frequency clock signal.

25. The wireless communication device of claim 24 wherein the frequency reduction unit comprises at least one of a first divider and a second divider, said second divider adding less noise to the input clock signal, wherein the frequency reduction unit reduces the frequency of the clock signal by selecting one of the first and second dividers and dividing the frequency of the clock signal using the selected divider.
